(19) United States
(12) Patent Application Publication
(10) Pub. No.: US 2026/0258899 A1
(43) Pub. Date: Sep. 3, 2026

(54) TUBE WITH FLAME RETARDANT LAYER

(71) Applicant: TI Automotive (Fuldabrueck) GmbH, Fuldabrueck (DE)

(72) Inventors: Andre HAECKLE, Waldeck (DE); Frank FAHRENHOLZ, Kassel (DE); Martin SCHRAMOWSKI, Kassel (DE); Siegfried ARNOLD, Kassel (DE)

(21) Appl. No.: 18/879,638

(22) PCT Filed: Jul. 6, 2023
(86) PCT No.: PCT/EP2023/068759

§ 371 Date: Dec. 27, 2024

(30) Foreign Application Priority Data
Jul. 7, 2022 (DE) 20 2022 103 802.3

(51) Int. Cl. F16L 57/04; B32B 1/08; B32B 27/08; B32B 27/20; B60H 1/00; F16L 9/12; F16L 37/088

(52) U.S. Cl. CPC F16L 57/04; B32B 1/08; B32B 27/08; B32B 27/205; F16L 9/123; F16L 37/088; B32B 2250/04; B32B 2264/108; B32B 2264/203; B32B 2307/3065; B32B 2307/538; B32B 2307/7376; B32B 2597/00; B60H 1/00571

(57) ABSTRACT

The disclosure relates to a tube comprising a flame retardant layer and anouter layer, where the outer layer envelops the flame retardant layerand the flame retardant layer comprises a thermoplastic materialand expandable graphite particles. The expandable graphite particles are designed to expand above a starting temperature, and the expandable graphite particles are in a nonexpanded state. The outer layer has a thermoplastic material, and a center roughness value Ra of an exterior side of the tube or an exterior side of the outer layer measures less than or equal to 200 or 100 or 50 μm.

### RELATED APPLICATIONS

The present disclosure claims priority to and is a national phase application of PCT Application PCT/EP2023/068759, filed Jul. 6, 2023, which claims the benefit of and priority to German Application 202022103802.3, filed on Jul. 7, 2022, the entire contents of each of which are incorporated herein by reference.

### FIELD

The disclosure relates to a tube comprising a flame retardant layer and an outer layer, wherein the outer layer envelops the flame retardant layer, wherein the flame retardant layer comprises a thermoplastic material and expandable graphite particles, wherein the outer layer has a thermoplastic material. The disclosure also relates to a fluid line with such a tube, as well as to a use of this tube or this fluid line.

### BACKGROUND

Such a type of tube is known from EP 3 271 170 B1, wherein the flame retardant layer or a reinforcing layer represents the outermost layer, depending on the exemplary embodiment. The reinforcing layer comprises fibers, for example which consist of aramid or can be glass fibers. The fibers are connected with each other to form a fabric, and hence a nonhomogeneous layer, which protects the flame retardant layer lying underneath. As a result of the flame retardant layer, the tube withstands fire or heat for a few seconds or minutes longer. The flame retardant layer is about 1.5 mm thick, and comprises an expandable graphite, the particles of which have an average particle size of 0.2 to 0.4 mm. The tube is attached to a line connector by means of a frictional connection.

We have discovered a disadvantage to the known tubes is the capacity for an especially durable fluidic connection. It was found that the mechanical connection—above all in a demanding environment, like in a land vehicle—between the known tube and an accompanying line connector leaves much to be desired. In particular the vibrations of a land vehicle can loosen the frictional connection between the tube and line connector over the years. The increased brittleness of the raw material also contributes to this, so that this factor decisively weakens the frictional connection as well over the years. Apart from the usual ageing of material, the brittleness in turn stems among other things from high temperatures or temperature fluctuations, which act on the land vehicle or on the tube in the latter. Finally, the land vehicle is exposed to moisture and road salt and the like, which likewise can have negative consequences for the frictional connection between the tube and line connector.

### SUMMARY

Therefore, the present disclosure provides a tube which-including in particular under adverse circumstances in the case of land vehicles-enables an especially durable or robust connection with a line connector, and which resists heat for as long as possible given a fire.

The tube comprises a flame retardant layer and an outer layer, wherein the outer layer envelops the flame retardant layer, wherein the flame retardant layer comprises a thermoplastic material and expandable graphite particles, wherein the expandable graphite particles are designed to expand above a starting temperature, wherein the expandable graphite particles are in a nonexpanded state, wherein the outer layer has a thermoplastic material, wherein a center roughness value Ra of an exterior side of the tube or an exterior side of the outer layer measures at most 200 or 100 or 50 μm.

The disclosure is initially based upon the discovery that welding the tube with a line connector enables a significantly better and more durable connection between these two components. It was found that neither a flame retardant layer with expandable graphite nor especially a fabric layer, and thus a nonhomogeneous layer, are suitable for welding with the line connector.

The disclosure is further based upon the discovery that the known flame retardant layer with expandable graphite has too great a surface roughness or too great a center roughness value. This is because the particles of expandable graphite generate a considerable roughness, which significantly increases rejected parts due to the laser welded joints between the tube and line connector. It is greatly advantageous for the laser welded joint that the surfaces joined together form a practically ideal form closure, so that the circumferential weld seam is actually continuous in all possible connections between the tube and line connector.

It was further found for a laser welded joint that either the material of the line connector or that of the tube should be largely transparent to laser radiation, while the material of the respective inwardly lying component largely absorbs the laser radiation. However, it is also desireable to have black colored line connectors and tubes. Special dyes satisfy the requirement of transparency for (near infrared) laser beams on the one hand, and of a black appearance in the visible light spectrum on the other. However, these special dyes are comparatively expensive, which is why they are used predominantly in line connectors. The quantity of material for the line connectors is hence most often smaller than for the tubes.

Therefore, the tube is preferably plugged into the line connector so that the exterior surface of the tube is welded with the interior surface of the line connector. It was found that low center roughness values of the exterior side of the tube enable especially good connections, in particular welded joints, and very especially laser welded joints. This is preferably achieved by virtue of the outer layer at most having small particles and/or the thermoplastic material of the outer layer preferably being homogeneous in design. Examples of plastics with a nonhomogeneous design include fabric layers or foams. The layer arrangement of the tube according to the disclosure thus enables a heat-resistant tube, which permits especially durable connections with line connectors.

The term “center roughness value” refers to the arithmetic center roughness value according to DIN EN ISO 4287:2010 and DIN EN ISO 4288:1998, or other substantially similar standards. In order to record a measuring distance, the measuring device is guided along a circumferential direction of the tube, for which purpose several axially offset rotations are potentially performed or a spiral course is carried out.

According to a preferred embodiment, the outer layer in a cross section of the tube has particles or cavities or filled cavities with an average expansion in a radial direction of at most 200 or 150 or 100 or 50 μm or even no particles or cavities or filled cavities. This contributes to a low center roughness value. For example, determination can involve inspecting a tube section with a length of 10 mm, in particular per μCT. If less than 100 or 50 or 20 or 10 particles/cavities/filled cavities with an expansion in a radial direction of at least 5 or 2 or 1 μm were found, the “no particles at all” criterion is regarded as satisfied.

According to a preferred embodiment, the thermoplastic material of the outer layer is homogeneously formed over the entire cross section of the outer layer. This improves the weldability of the outer layer. The term “homogeneous” preferably refers to a structure with only one inner and only one outer intentionally generated boundary surface in a cross section. Isolated, even very small shrink holes (in roughly the submillimeter range) are not intentional, for example. By contrast, foams intentionally have blisters, and hence inner boundary surfaces. Likewise, additive particles are intentionally added particles, so that numerous intermediary boundary surfaces can be found between the inner and outer boundary surface of the layer, even in the case of additive particles. Neither is the thermoplastic material of the outer layer homogeneously formed over the entire cross section of the outer layer if it has the form of a fabric or a fabric layer.

The same applies for a case in which the outer layer in the form of a fabric is additionally saturated with another plastic as well. A fabric layer saturated in this way may have no particles or cavities or filled cavities whatsoever if the cast material and the fabric material are viewed as a coherent plastic structure in relation to which the particles or cavities or filled cavities are defined. The particles or the filled cavities can consist of a material other than plastic. In particular, the particles can be of a mineral nature, while the filled cavities can comprise in particular a gas-primarily air. If particles or cavities or filled cavities are completely absent, however, a porous plastic layer filled with another plastic can then still be present. This includes in particular a fabric layer saturated with a thermoplastic material. However, such layers then do not comprise a thermoplastic material formed homogenously over the entire cross section of the outer layer. A thermoplastic material is preferably homogenously formed when at most 100 or 50 or 20 structures are found within a tube section with a length of 10 mm, which preferably have a size of at least 5 or 2 or 1 μm-most preferably according to a μCT recording.

It is preferred that the tube be designed as a single piece and/or unitary body. The outer layer is irreversibly connected with the flame retardant layer directly or indirectly with one or several layers interspersed. As a consequence, the individual layers of the tube are firmly connected with each other, and ensure a corresponding mechanical stability. In order to verify that the tube layers are irreversibly connected, a center piece of the tube is best inspected with any line connectors disconnected. For example, if an outer protective tube can be removed from the tube, the layer or layers of the protective tube do not belong to the tube or inner tube located therein. For example, it may be that a tube or inner tube is materially connected with a line connector, while an outer protective tube might not be materially connected with the tube, but is with the line connector. In these cases, the outer protective tube and the tube or inner tube would basically also be indirectly materially connected with each other via the line connector(s). A tube is in this instance only a single piece if the layers can only be separated from each other irreversibly, and hence destructively, given a randomly extracted center section of the tube with line connectors separated. For example, if a tube or inner tube with an outer protective tube is cut away from the line connectors, the tube is in any event not designed as a single piece if the protective tube can be pulled off of the tube or inner tube by hand and preferably also pushed back on again.

According to a preferred embodiment, the outer layer is the outermost layer of the—in particular one-piece—tube. It is possible for a one-piece tube or inner tube to have an outer layer and simultaneously be enveloped by a sliding protective tube. The outer layer of the tube or inner tube is then at the same time the outermost layer of the one-piece tube or inner tube, because the protective tube can be pulled from the tube or inner tube given a separation of line connectors.

It is advantageous for the flame retardant layer to have a layer thickness of at most 1.5 or 1.0 or 0.7 or 0.5 mm. This prevents the tube from becoming too thick, and hence too inflexible for any bending to be done. It is advantageous for the layer thickness of the flame retardant layer to measure at least 0.05 or 0.07 or 0.10 mm. This prevents layer breakage.

It is preferred that the outer layer have a layer thickness of at least 0.06 or 0.08 or 0.10 mm. Otherwise, it can happen that the flame retardant layer will tear off during extrusion due to the expandable graphite particles, as a result of which the flame retardant layer is not comprehensive in design. The layer thickness of the outer layer advantageously measures at most 1.0 or 0.8 or 0.6 mm. This prevents the tube from becoming too thick, and hence too inflexible for any bending to be done. It is preferred that the layer thickness of the outer layer be designed so as to smooth out bumps on the underlying flame retardant layer. A cumulative layer thickness of the outer layer and the flame retardant layer preferably measures at least 0.15 or 0.2 or 0.25 or 0.3 mm. A cumulative layer thickness comprised of the layer thickness of the flame retardant layer and the layer thickness of the outer layer best comes to at most 2.0 or 1.5 or 1.0 mm.

The percentage by weight of the expandable graphite particles in the flame retardant layer advantageously measures at least 1 or 3 or 5 or 7 or 9% w/w. The percentage by weight of the expandable graphite particles in the flame retardant layer best comes to at most 50 or 40 or 30% w/w. It was found that too high a percentage by weight of the expandable graphite particles causes bumps or too high a brittleness.

According to a preferred embodiment, the expandable graphite particles in the flame retardant layer have an average height in a radial direction of at most 200 or 150 or 100 or 70 μm in a cross section of the tube As a result, the center roughness value on the exterior side of the tube or the exterior side of the outer layer does not get too large. The expandable graphite particles in the flame retardant layer advantageously have an average height in the radial direction of at least 10 or 20 or 30 μm in a cross section of the tube. Among other things, this ensures that a/the expansion rate of the expandable graphite particles will not get too low.

It is advantageous for the expandable graphite particles of the flame retardant layer to have a starting temperature of at least 130 or 150 or 170 or 190 or 210 or 230° C. It is best that the starting temperature of the expandable graphite particles be adjusted in particular to the melting temperature of the thermoplastic material of the flame retardant layer. The starting temperature of the expandable graphite particles is at least 10 or 20 or 30° C. higher than the melting temperature of the thermoplastic material of the flame retardant layer.

An expansion rate of the expandable graphite particles of the flame retardant layer preferably measures at least 10 or 20 or 30 cm³/g. An expansion rate of the expandable graphite particles of the flame retardant layer advantageously comes to at most 350 or 250 or 200 or 150 cm³/g. It was found that a very high expansion rate requires those kinds of expandable graphite particles whose size is too large for the layer thicknesses of the tube. The disclosure is based upon the discovery that in particular expansion rates of around 100 cm³/g are sufficient for intumescence on the one hand, and enable small enough expandable graphite particles on the other.

It is preferred that the tube comprise an auxiliary flame retardant, wherein the auxiliary flame retardant preferably has a gas-diluting or oxygen-diluting effect, wherein the auxiliary flame retardant is preferably an inorganic flame retardant. This makes it possible to correspondingly additionally or even synergistically support the flame retardant layer with the auxiliary flame retardant. It is especially preferred that the auxiliary flame retardant contain ammonia, and for example comprise ammonium phosphate, ammonium sulfate and/or ammonium polyphosphate. It is possible for the auxiliary flame retardant to be located in the flame retardant layer and/or in the outer layer. The auxiliary flame retardant is especially preferably only contained in the flame retardant layer.

The tube preferably comprises at least one additional, preferably an inner, layer. This allows for complex tube structures. It is possible for the tube to have additional inner layers. The flame retardant layer preferably envelops the at least one inner layer. It is possible for the flame retardant layer to abut against the at least one inner layer. The at least one additional, preferably inner layer can be materially connected with the flame retardant layer. The inner layer can be the innermost layer. It is possible for an additional layer or several additional layers to be arranged between the innermost layer and the flame retardant layer. A separating layer is advantageously arranged between the innermost layer and the flame retardant layer, wherein the separating layer preferably serves to spatially decouple the flame retardant layer and the innermost layer.

The at least one inner layer preferably comprises a thermoplastic material. This ensures coextrusion even in the case of the at least one inner layer. The thermoplastic material of the at least one additional inner layer can be a polyester, a polyolefin, a polyurethane or a thermoplastic elastomer. In particular, the polyester can be polyethylene terephthalate (PET). It is possible for a barrier layer to be arranged between the additional inner layer and the flame retardant layer. For example, the barrier layer can comprise an ethylene-vinyl alcohol copolymer (EVOH) or a fluoropolymer. It is advantageous for a/the separating layer to be arranged between the barrier layer or the innermost layer and the flame retardant layer.

It is preferred that the tube be manufactured at least partially and preferably completely by means coextrusion.

The thermoplastic materials of the flame retardant layer and/or the thermoplastic material of the outer layer can be a polyamide, a polyester, a polyolefin, a polyurethane, a thermoplastic elastomer or a blend of the aforementioned plastics. In particular PET is possible as the polyester.

According to a preferred embodiment, the thermoplastic material of the outer layer comprises a thermoplastic elastomer, preferably a thermoplastic vulcanizate and especially preferably Santoprene. Thermoplastic vulcanizates comprise ethylene-propylene-diene rubber (EPDM) particles in a matrix of polypropylene. It is very preferred that the thermoplastic materials of the flame retardant layer be a polyolefin and preferably a polypropylene. According to a preferred embodiment, the tube comprises two, and preferably only two inner layers. The innermost layer advantageously comprises a thermoplastic material, preferably a thermoplastic elastomer, further preferably a thermoplastic vulcanizate, especially preferably Santoprene. It is preferred that the second inner layer be arranged between the innermost layers and the flame retardant layer, and that it be a separating layer. It is advantageous that the separating layer have a thermoplastic material, preferably a polyolefin and especially preferably a polypropylene. It is especially advantageous for all layers of the tube to have a shared plastic, preferably polypropylene. The shared plastic of all layers preferably serves to safeguard the layer composite especially well against delamination. The material polypropylene is especially suitable as a barrier material with respect to aqueous solutions, for example water-glycol solutions, so that a polypropylene composite is especially suited as a heat exchanger tube.

A fluid line preferably comprises at least one aforementioned tube according to the disclosure and at least one line connector. It is preferred that the tube and the at least one line connector be welded together. This creates an especially durable, fluid connection. The line connector advantageously comprises a thermoplastic material. It is especially preferred that the thermoplastic material of the line connector be a plastic from the group “polyamide, polyester, polyolefins, polyurethane, thermoplastic elastomer” or a blend of two or more plastics from the aforementioned group. The plastic of the line connector preferably belongs to the same plastic group as the thermoplastic material of the outer layer and/or the thermoplastic material of the inner layer. For example, if the thermoplastic material of the outer layer is a polyamide, the thermoplastic material of the line connector is preferably likewise a polyamide. The thermoplastic material of the line connector and the thermoplastic material of the outer layer and/or inner layer very especially preferably belong to the same plastic type, for example PA6 or PA11 or PA12. It is possible for the thermoplastic material of the line connector to originate from the same material storage container as the thermoplastic material of the outer layer and/or the inner layer.

It is preferred that the tube and the line connector be welded together, and preferably be connected with each other by means of laser welding. It is possible for the tube and the line connector to be connected with each other by means of rotary friction welding or mirror welding. The tube is preferably inserted into a connecting section of the line connector. It is possible for the tube to be inserted onto a connecting section of the line connector. The connecting section best comprises at least one circumferential weld seam. It is possible for the connecting section to have two or more circumferential weld seams. It is possible for the connecting section of the line connector to comprise an inner and an outer weld seam, which connect the connecting section of the line connector with the tube.

The line connector preferably comprises a coupling body. The coupling body advantageously has a one-piece, especially preferably an integral design. The term “integral” preferably refers to being manufactured in a single injection molding process. The coupling body preferably comprises a coupling section for a counter-piece to be coupled with the line connector. The counter-piece is best a plug, which is introduced into the line connector. The coupling body is advantageously designed in such a way that a counter-piece can be introduced into the coupling section-preferably reversibly. The coupling body preferably has a/the connecting section for connection with the tube. The connecting section can be designed to be inserted into and/or onto the tube. For example, if the connecting section is designed as a circumferential groove into which the tube is introduced, the tube is simultaneously inserted onto an inner wall of the circumferential groove and into an outer wall of the circumferential groove.

In particular, the line connector can have a retainer. For example, the retainer can be roughly U-shaped in design, and have a U-base as well as two U-legs. According to an embodiment, the retainer can be completely circumferential in design. The counter-piece can have a latching element, for example which is designed as a circumferential collar or as a circumferential groove.

The latching element of the counter-piece or plug advantageously latches with the retainer of the line connector while introducing the counter-piece into the line connector. According to an embodiment, the coupling body can be two-part in design, and have a connecting part as well as a coupling part. It is possible for the connecting part and the coupling part to be connected with each other via a latching connection or via a screw connection. The line connector best comprises a seal. For example, the seal can have a sealing ring or two sealing rings consisting of an elastic material.

The tube according to the disclosure or a fluid line according to the disclosure may be part of a land vehicle, and in particular in an electric vehicle. The tube or the fluid line is preferably used for cooling, preferably for cooling a battery of an electric vehicle drive. It is preferred that the tube or the fluid line be used to carry an aqueous solution, and in particular a water-glycol solution. For example, the tube or the fluid line can serve as a feed line to a tube system of the battery of the electric vehicle drive. It is advantageous for the tube or the fluid line be designed to sustain cooling of the battery of the electric vehicle drive for several seconds or minutes longer than conventional tubes or fluid lines without a flame retardant layer, thereby giving the vehicle passengers correspondingly more time for escape or recovery. Cooling the battery of the electric vehicle is here especially critical, since too high a battery temperature will cause the battery to catch fire that much faster.

### BRIEF DESCRIPTION OF THE DRAWINGS

The tube according to the disclosure or the fluid line according to the disclosure will be schematically illustrated below based on figures in exemplary embodiments. Shown on:

FIG. 1 is a cross section of the tube according to the disclosure,

FIG. 2 is a longitudinal section through a fluid line according to the disclosure comprising the tube on FIG. 1 and a line connector with a counter-piece inserted,

FIG. 3 is a front view of a retainer of the line connector, and

FIG. 4A to 4Care three additional variants of fluid lines, whose respective connecting section is shown in longitudinal section.

### DETAILED DESCRIPTION

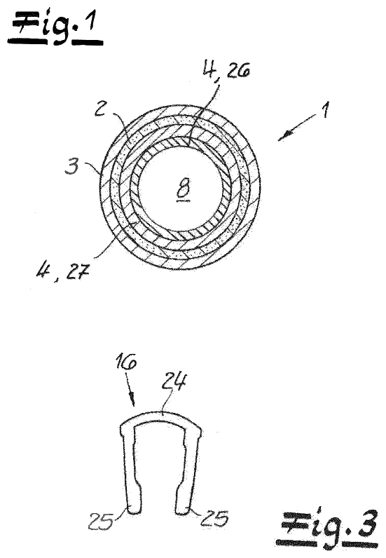

According to an exemplary embodiment shown on FIG. 1, a tube according to the disclosure can comprise four layers 2, 3, 26, 27, which envelop a lumens 8 of the tube. The tube 1 has a flame retardant layer 2 as well as an outer layer 3, and beyond that can also comprise another two inner layers 4. In this exemplary embodiment, the flame retardant layer 2 is respectively connected materially with the outer layer 3 and the inner layer 4 through coextrusion. In this exemplary embodiment, the inner layer 4, 26 forms the innermost layer 26 of the tube 1, which is separated from the flame retardant layer 2 by a preferred separating layer 27. FIG. 1 does not show possible protective tubes, for example which are designed like a corrugated tube and envelop the tube 1 without being materially directly connected with the latter. In this exemplary embodiment, the outer layer 3 is the outermost layer of the tube 1 with a one-piece design.

All layers 2, 3, 26, 27 of the tube 1 most advantageously comprise a thermoplastic material. It is possible for the flame retardant layer 2 to have a polypropylene, in particular an isotactic polypropylene. In this exemplary embodiment, the separating layer 27 comprises a polypropylene and preferably an isotactic polypropylene. In this exemplary embodiment, the outer layer 3 and the innermost layer 26 can have a thermoplastic vulcanizate, in particular Santoprene. The material of the innermost layer 26 preferably originates from the same material supply container as the material of the outer layer 3.

Since thermoplastic vulcanizates likewise have polypropylene, all layers of the tube 1 comprise polypropylene in this exemplary embodiment, which is why good fabric closures are achieved between the four layers 2, 3, 26, 27 of the tube 1. In addition, the polypropylene composite of the tube 1 is particularly well suited for carrying an aqueous solution—in particular a water-glycol solution. Polypropylenes absorb little water, which makes them more resistant to water by comparison to the more expensive polyamides, for example. In particular, the tube in this exemplary embodiment can be a feed line to a tube system of a drive battery of an electric vehicle.

According to the disclosure, the flame retardant layer 2 comprises expandable graphite particles, as correspondingly denoted on FIG. 1. The expandable graphite particles are preferably flakelike in design, and embedded in the polypropylene of the flame retardant layer 2. In this exemplary embodiment, the percentage by weight of expandable graphite particles in the flame retardant layer 2 measures at least 10%. For example, the expandable graphite particles can have an average thickness of 25 μm. Due to the flakelike shape, the surface of the expandable graphite particles essentially comprises an upper side and a lower side, which can extend in both directions along several 100 μm. If the expandable graphite particles were sieved, 85% of the particles could fall through a sieve opening of 180 μm (85% of the particles finer than 80 mesh), for example. The expandable graphite in this exemplary embodiment could expand by 100 cm³/g at 1000° C.

A melting temperature of the isotactic propylene in the layers 2 and 27 can measure 185° C. The melting temperature of the thermoplastic vulcanizate of the outer layer 3 and the innermost layer 26 can come to 165° C. It is preferred that a starting temperature of the expandable graphite particles measure 210° C. This means that the temperature of the polypropylene melt in this exemplary embodiment is to be set to about 190 to 200° C., so as to prevent the expandable graphite particles from still expanding during tube extrusion.

In this exemplary embodiment, the exterior side of the outer layer 3 has a center roughness value Ra of 50 μm. This center roughness value Ra is primarily caused by the expandable graphite particles in the flame retardant layer 2, but partially leveled by the thermoplastic material of the flame retardant layer 2, since the thermoplastic material of the flame retardant layer 2 also serves as filler in the flame retardant layer 2. The unevenness in the flame retardant layer 2 is further leveled out by the outer layer 3, which in this exemplary embodiment is microscopically homogeneous in design, and in particular has neither gas bubbles nor particles above a maximum particle expansion of 1 μm. It is preferred that the layer thickness of the flame retardant layer 2 measure about 200 μm. The layer thickness of the outer layer 3 can come to 250 μm. The layer thickness of the separating layer 27 measures 150 μm in this exemplary embodiment. The layer thickness of the innermost layer 26 can come to 150 μm.

According to FIG. 2, the tube 1 shown on FIG. 1 is connected with a line connector 5 via a welded joint 7, 18 to yield a fluid line 1, 5. The line connector

5 comprises a coupling body 11, which in this exemplary embodiment is preferably one-piece, and further preferably integral in design, and was fabricated via injection molding out of a thermoplastic material-preferably out of polypropylene. Because the thermoplastic vulcanizates of the outer layer 3 and the innermost layer 26 likewise comprise polypropylene, this yields a particularly good welded joint 7, 18. The coupling body 11 best comprises a coupling section 14 as well as a connecting section 15. The welded joint 7, 18 is arranged in the area of the connecting section 15 in this exemplary embodiment. The welded joint 7, 18 can comprise an outer weld seam 7 as well as an inner weld seam 18. In this exemplary embodiment, the two weld seams 7, 18 were generated by means of rotary friction welding, wherein the tube 1 was inserted into a tube receptacle 17 of the line connector 5 or of the connecting section 15.

The tube receptacle 17 is best limited by a stop 13 in an axial direction, and is preferably designed as a circumferential, annular groove. In particular, the tube receptacle 17 can have an outer wall 20 as well as an inner wall 21. The inner wall 21 in this exemplary embodiment can taper in an axially inward direction, and hence in the direction of the tube 1 on its exterior side, making it especially easy to slip the tube 1 onto the inner wall 21. The tapering of the inner wall 21 is relatively pronounced on FIG. 2, and can be distinctly weaker in other embodiments.

In the rotary friction welding process, the inserted tube 1 is advantageously fixedly held, while the line connector 5 is made to rotate. The rotation is so fast that the generated frictional heat in the tube receptacle 17 is enough to melt the material on the boundary surfaces. This results in particular in an outer weld seam 7 as well as an inner weld seam 18. Another weld seam not shown here may arise directly on the groove base of the tube receptacle 17 or on the stop 13. It is essential for clean weld seams 7, 18 that the unevenness of the expandable graphite particles in the flame retardant layer 2 be smoothed out by the inner layers 4 and the outer layer 3.

In the exemplary embodiment according to FIG. 2, the coupling body 11 comprises a fluid channel 10, which connects the connecting section 15 with the coupling section 14. In particular, the connecting section 15 may have the kind of axial expansion corresponding to the overlap from the tube 1 and the coupling body 11 in an axial direction. In the longitudinal section according to FIG. 2, a counter-piece 9 is introduced into the line connector 5 or into the coupling section 14. The counter-piece 9 may be the tip of another undepicted tube, or of a terminal element of an aggregate, for example a tank/a pump/a valve/a battery. The counter-piece 9 can have a latching element 23, which preferably can be designed as a circumferential collar, but also as a circumferential groove.

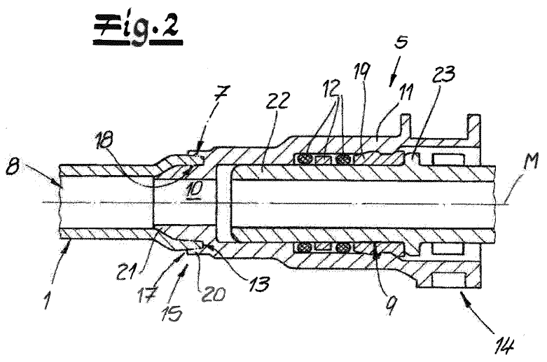

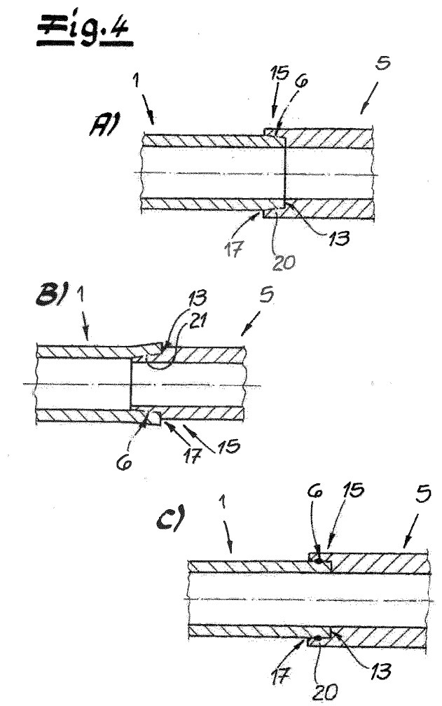

The line connector 5 best comprises a retainer 16 of the kind exemplarily illustrated on FIG. 3. In particular in a front view, the retainer 16 can be essentially U-shaped in design, and have two legs 25. The legs 25 can be connected with each other via a U-base, which forms an activating section 24. The retainer 16 can be pushed into the coupling body 11 or into the coupling section 14 on FIG. 2 by manually pressing on the activating section 24 in a radial direction. If the counter-piece 9 is then introduced into the line connector 5 in an axial direction, the latching element 23 of the counter-piece 9 elastically spreads apart the legs 25 of the retainer 16. As soon as the latching element 23 has passed the legs 25 of the retainer 16, the legs 25 snap back due to the elastic restoring energy, thereby securing the counter-piece 9 in the line connector 5.

The line connector 5 can also have a seal 12, which in this exemplary embodiment comprises two sealing rings and a spacer lying in between. A plug shaft 22 of the counter-piece 9 is best designed in such a way as to generate a frictional connection with the seal 12, as a result of which a fluidic seal is achieved. In particular, the seal 12 can be secured by a seal holder 19, so that the seal 12 is also secured in an axially outward direction. In this exemplary embodiment, an inner wall of the coupling body 11 as well as the plug shaft 22 of the counter-piece 9 and the connecting section 15 along with the tube 1 connected thereto are concentric to each other in design, and have a shared center axis M. In other exemplary embodiments, the connecting section 15 and the coupling section 14 can be angled relative to each other.

FIG. 4 shows three variants A to C of additional welded joints 6, 21 between the tube 1 and a line connector 5. In the case of FIG. 4A, the connecting section 15 of the line connector 5 comprises a tube receptacle 17, into which the tube 1 is inserted. As opposed to FIG. 2, the tube receptacle 17 has no inner wall, but rather only an outer wall 20 as well as a stop 13. Given the absence of any inner wall of the tube receptacle 17, there is no inner weld seam, but rather a single weld seam 6. For example, the single weld seam 6 can be manufactured via rotary friction welding.

FIG. 4B shows another embodiment of a welded joint 21 between a tube 1 and a line connector 5. In this exemplary embodiment, the connecting section 15 comprises a tube receptacle 17, which has no outer wall, but instead an inner wall 21. The exterior side of the inner wall 21 is tapered in design in an axially inward direction, so that the tip of the tube 1 increasingly expands when slipping on the tube 1, and forms an increasing frictional connection. In this embodiment, the tube 1 may also be slipped on up to a stop 13 of the line connector 5 or the connecting section 15 or the tube receptacle 17. A weld seam 6 can be generated via rotary friction welding.

On FIG. 4C, the connecting section 15 comprises a tube receptacle 17, which is essentially hollow cylindrical in design, and closed by a stop 13. In particular, the tube receptacle 17 can be configured in such a way that an inner wall of the tube 1 merges into an inner wall of the line connector 5. In this exemplary embodiment, the material of the line connector 5 or the connecting section 15 is transparent in design for laser beams, in particular for near infrared laser beams, due to a special dye additive, but black colored in the visible spectrum. By contrast, the material of the tube 1 is nontransparent for the same laser beams, so that the laser beams are absorbed at the boundary surface between an exterior side of the tube 1 and an interior side of the tube receptacle 17. Since the tube 1 is preferably given a dark or black color with the help of a conventional pigment, a uniform color appearance of the fluid line 1, 5 is achieved, while the laser beams in the tube receptacle 17 can simultaneously only penetrate up until the tube 1.

The laser beam or the laser beams can be guided in such a way as to generate a complete circulation, which results in a correspondingly circumferential weld seam 6. Since the laser beams are comparatively fine in design, and only a moderately strong frictional connection is generated between the tube 1 and the line connector 5, an especially uniform surface of the exterior surfaces of the tube 1 or of the outer layer 3 is advantageous. The center roughness value for the exterior side of the tube 1 in the exemplary embodiment according to FIG. 4C especially preferably measures less than 50 μm, for example 20 μm. This generates an especially durable fluidic connection between the tube 1 and the line connector 5, while the tube 1 simultaneously provides an especially good flame protection.

Reference List

| | |
|---|---|
| 1 | Tube |
| 2 | Flame retardant layer |
| 3 | Outer layer |
| 4 | Inner layer |
| 5 | Line connector |
| 6 | Single weld seam |
| 7 | Outer weld seam |
| 8 | Lumens of 1 |
| 9 | Counter-piece |
| 10 | Fluid channel of 5 |
| 11 | Coupling body of 5 |
| 12 | Seal of 5 |
| 13 | Stop of 5 |
| 14 | Coupling section of 11 |
| 15 | Connecting section of 11 |
| 16 | Retainer of 5 |
| 17 | Pipe receptacle of 11, 15 |
| 18 | Inner weld seam |
| 19 | Seal holder of 5 |
| 20 | Outer wall |
| 21 | Inner wall |
| 22 | Plug shaft of 9 |
| 23 | Latching element of 9 |
| 24 | Activating section of 16 |
| 25 | Leg of 16 |
| 26 | Innermost layer |
| 27 | Separating layer |
| 1, 5 | Fluid line |
| M | Center axis |
| 6, 7, 18 | Welded joint |

1. A tube comprising a flame retardant layer and an outer layer, wherein the outer layer envelops the flame retardant layer, wherein the flame retardant layer comprises a thermoplastic material and expandable graphite particles, wherein the expandable graphite particles are configured to expand above a starting temperature, wherein the expandable graphite particles are in a nonexpanded state, wherein the outer layer has a thermoplastic material, and wherein a center roughness value Ra of an exterior side of the tube or an exterior side of the outer layer measures less than or equal to 200 μm.

2. The tube according to claim 1, wherein the outer layer in a cross section of the tube has particles or cavities with an average expansion in a radial direction of less than or equal to 200 μm.

3. The tube according to claim 1, wherein the thermoplastic material of the outer layer is homogeneously formed over the entire cross section of the outer layer.

4. The tube according to claim 1, wherein the tube is designed as a single piece.

5. The tube according to claim 1, wherein the outer layer is the outermost layer of the tube.

6. The tube according to claim 1, wherein the flame retardant layer has a layer thickness of less than or equal to 1.0 mm.

7. The tube according to claim 1, wherein the outer layer has a layer thickness of at least 0.05 mm.

8. The tube according to claim 1, wherein the percentage by weight of the expandable graphite particles in the flame retardant layer measures at least 1% w/w.

9. The tube according to claim 1, wherein the expandable graphite particles in the flame retardant layer have an average height in a radial direction of less than or equal to 200 μm in a cross section of the tube.

10. The tube according to claim 1, wherein the expandable graphite particles of the flame retardant layer have a starting temperature of at least 130° C.

11. The tube according to claim 1, wherein an expansion rate of the expandable graphite particles of the flame retardant layer measures at least 10 cm³/g.

12. The tube according to claim 1, wherein the tube comprises an auxiliary flame retardant, wherein the auxiliary flame retardant preferably has a gas-diluting or oxygen-diluting effect, wherein the auxiliary flame retardant is an inorganic flame retardant.

13. The tube according to claim 1, wherein the tube comprises at least one inner layer, wherein the flame retardant layer envelops the inner layer, wherein the flame retardant layer abuts against the at least one inner layer.

14. The tube according to claim 1, wherein the thermoplastic material of the flame retardant layer and/or the thermoplastic material of the outer layer comprise a polyamide, a polyester, a polyolefin, a polyurethane or a thermoplastic elastomer.

15. A fluid line, comprising at least one tube constructed according to claim 1 and at least one line connector, wherein the tube and the at least one line connector are welded together.

16. A land vehicle having an electric vehicle drive with a battery and a fluid line according to claim 15, wherein the fluid line is connected to the electric vehicle drive for thermal management of the battery.

17. The tube according to claim 1, wherein the center roughness value Ra of an exterior side of the tube or an exterior side of the outer layer measures less than 50 μm.

18. The tube according to claim 1, wherein the particles or cavities have an average expansion in a radial direction of less than 50 μm or even no particles or cavities or filled cavities.

19. The tube according to claim 1, wherein the the outer layer in a cross section of the tube has no particles or cavities or filled cavities.
